(19) United States
(12) Patent Application Publication
(10) Pub. No.: US 2011/0065079 A1
(43) Pub. Date: Mar. 17, 2011

(54) METHOD USING EXERCISE TO RANDOMLY IDENTIFY CHAPTERS IN THE BIBLE FOR STUDY

(76) Inventor: Kathy A. Boswell, Hoover, AL (US)

(21) Appl. No.: 12/561,993

(22) Filed: Sep. 17, 2009

(51) Int. Cl. G09B 19/00; G06F 7/58; A63B 71/00; B65D 77/00

(52) U.S. Cl. 434/245; 708/250; 482/8; 206/216

(57) ABSTRACT

A method for randomly identifying a chapter in the Bible from the number of repetitions of a physiological action that occurs during exercise. A physiological measuring device is attached to one or more body parts and the numerical cumulative occurrence of one or more physiological actions are recorded on the physiological measuring device over a period of time. A number is obtained having a sequence of three or more numerical digits reflecting the numerical cumulative occurrence from the physiological measuring device. One or more of the numerical digits are then selected randomly to identify a book in the Bible, and one or more of the numerical digits are selected randomly to identify a chapter in the identified book of the Bible.

### BACKGROUND OF THE INVENTION

1. Field of the Invention

The present invention relates to methods for facilitating interest in reading the Bible and, more particularly, to a system and method for identifying a chapter in the Bible for study from the number of repetitions of a physiological action occurring during a given period of time of exercise or other physical activity.

2. Technical Background

The Christian Bible is a compilation of the various books of the Old Testament and the New Testament. The Bible forms the basis for religious customs, beliefs, ideals, traditions, and religious practices in many cultures around the world. The teaching of the scriptures of the Bible is considered by those cultures to be of great importance in the education of children and adults and for carrying forward those religious beliefs and ideals to future generations. Each of the various books of the Bible, such as Genesis, Exodus, Psalms, Proverbs, Matthew, Mark, Luke, John, Acts, and Revelations, offers extensive teachings and parables in textual form requiring substantial attention and investment of time to assimilate into a comprehensive understanding.

Various educational devices have been advanced in an effort to stimulate this learning process and enhance the interest, education and understanding of the teachings of the scriptures of the Bible. U.S. Pat. No. 7,345,955 discloses a method and device providing a daily Bible reference corresponding to the month and date. The daily reminder may be a digital time device, a desk, wall, pocket or daily calendar, a portable telephone or a personal data assistant. A daily display is associated with a text display, the daily display comprising a specific Gregorian calendar date, the text display comprising an abbreviated name of a text reference work wherein the text display is associated with the specific Gregorian calendar date to constitute a complete biblical citation. U.S. Pat. No. 5,152,535 discloses an educational bible quiz game wherein the success of each participant depends partly on his or her knowledge of the Bible, and partly on chance. Cards with questions include the chapter and the verse in the New King James version of the Bible having the correct answer to the question. U.S. Pat. No. 6,390,015 discloses a bookmark which includes sliding indicators showing a specific chapter and verse of a book within the Bible. The back of a bookmark is used as a trivia game which includes a transparent pocket for containing a trivia question card. The card includes a printed Bible verse on its front side, and its location in the Bible, by book, chapter, and verse, on the back side. When the card is inserted into the pocket, the text of the verse is visible through the transparent cover, but the location is concealed. The players guess the location of the verse by sliding the arrow indicators to the chapter and verse they believe to be correct. They take turns guessing until the correct location is guessed. The players then insert a new trivia question card and repeat the process. The players learn the Bible's teachings, and their location in the Bible, by playing the game. U.S. Pat. No. 5,449,177 discloses an educational board game for teaching biblical knowledge in the context of three biblical characteristics of humankind presented in the books of the Bible. The game is played by selecting a scripture card, placing it on the corresponding scripture box, reading the cited scripture in the Bible and describing it in reference to the biblical personality type of the selected embodiment.

In the United States and in other countries physical exercise is becoming popular because of an increased understanding of the significance of daily exercise in maintaining health and preventing disease. Religious cultures believe that “spiritual exercise” is also important for creating and maintaining a healthy, productive, and meaningful life-style. The integration of both physical exercise and spiritual study may facilitate a mutual increased interest and participation in both of these activities.

### SUMMARY OF THE INVENTION

The present invention is a method for identifying a chapter in the Bible from the number of repetitions of a physiological action. A physiological measuring device is attached to one or more body parts and the numerical cumulative occurrence of one or more physiological actions are recorded on the physiological measuring device over a period of time. A number is obtained having a sequence of three or more numerical digits reflecting the numerical cumulative occurrence from the physiological measuring device. One or more of the numerical digits are then selected randomly to identify a book in the Bible, and one or more of the numerical digits are selected randomly to identify a chapter in the identified book of the Bible. To facilitate the method a numerical digit data entry form or recording media having three or more entry fields to enter a sequence of digits of the number into the entry fields can be used. A label of “book”, “chapter”, or no label can be assigned randomly to each of the entry fields, wherein at least one entry field is labeled as “book” and at least one entry field is labeled as “chapter”. One can then use one or more specific digits in the entry fields labeled as “book” to form a number identifying a specific book in the Bible, and one or more specific digits in the entry fields labeled as “chapter” to form a number identifying a specific chapter in the specific book. The physiological measuring device includes devices to measure total number of steps taken, total number of movements of an arm, total number of heart beats, total number of breaths taken, total number of calories burned, or total distance traveled, or a combination thereof. After a chapter is identified a user can read the chapter, reflect on the scriptural message, and make notes in the recording media.

An advantage of the present invention is the ability to stimulate a mutual interest in exercising and in reading the Bible by utilizing events that occur during exercise to provide a means for randomly identifying a chapter in the Bible for reading and spiritual reflection.

Another advantage is a simple and inexpensive method of measuring physiological actions over a period of time such as number of steps taken, number of heart beats, number of breaths taken, number of calories burned, or distance traveled to generate a number which can be used to randomly identify a book of the Bible and to randomly identify a chapter in that book for reading and spiritual reflection.

### BRIEF DESCRIPTION OF THE DRAWINGS

FIG. 1 illustrates numerical digit entry fields for each day showing the random labeling of some of the entry fields as “book” or “chapter”, with a number being entered by its individual digits into the entry fields, wherein the number is generated by cumulative measurement of a physiological event occurring repeatedly over a period of time.

FIG. 2 illustrates an example of a recording media 11 for recording the number of a book of the Bible and a number of a chapter in the book, wherein the number of the book and the number of the chapter are derived from the digit entry fields 10 which were labeled randomly as “book” or “chapter”.

FIG. 3 describes the steps of the method of the present invention for identifying a specific chapter in a specific book of the Bible by measuring the frequency of occurrence of a physiological event during exercise or physical activity. A user attaches a physiological measuring device to one or more parts of the body. The measuring device can be a pedometer, heart rate meter, or plethysmograph or a combination thereof (step 1). The user engages in physical activity or exercise for a desired period of time

### DETAILED DESCRIPTION OF THE INVENTION

While the following description details the preferred embodiments of the present invention, it is to be understood that the invention is not limited in its application to the details of construction and arrangement of the parts illustrated in the accompanying drawings, since the invention is capable of other embodiments and of being practiced in various ways.

The present invention is based upon the random selection of a specific book in the Bible and the random selection of a specific chapter in that book. The selection is based upon the use of a number generated by physical activity, using a measuring device which measures the total number of times a specific physiological action occurs over a given period of time. One way to obtain such a number is to measure the total number of steps taken during the day using a pedometer. There are many examples of other ways to obtain such a number, including measuring the total number of steps taken during running over a given period of time, the total number of times an arm is raised or lowered during an athletic activity such as swimming, the total number of heart beats that occur during a period of physical activity or exercise, and the total number of calories burned or respiratory movements made during a period of physical activity or exercise.

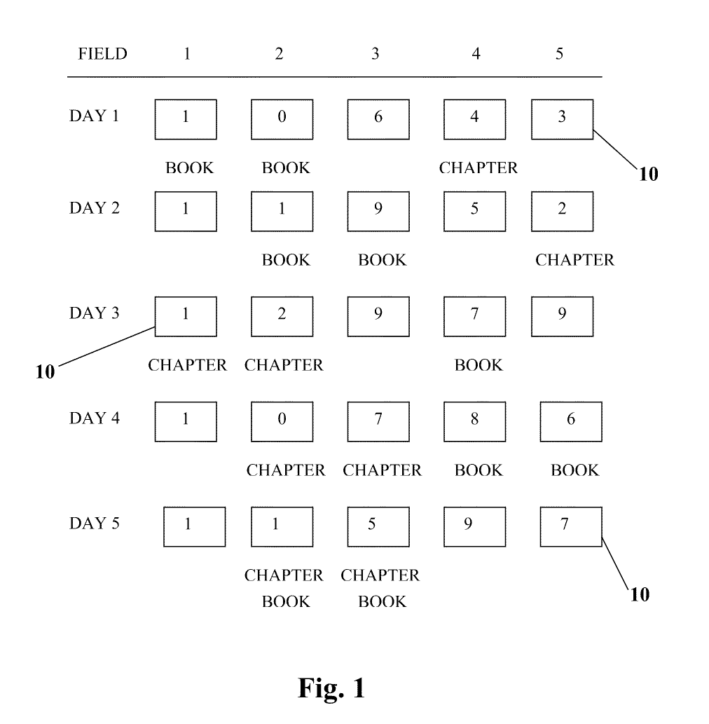

FIG. 1 illustrates numerical digit entry fields 10 for each day showing the random labeling of some of the entry fields as “book” or “chapter”, with a number being entered by its individual digits into the entry fields 10, wherein the number is generated by cumulative measurement of a physiological event occurring repeatedly over a period of time. Five entry fields 10 are shown for each day to accommodate a number of, preferably, five digits. At least one entry field is randomly labeled “Book” and at least one entry field is randomly labeled “Chapter”. On day one, for example, a person wearing a pedometer took 10,643 steps during the day, such as from 8:00 am to 4:00 pm. Entry fields 1 and 2 are labeled “Book” and entry field 4 is labeled “Chapter”. Thus, the number generated for day 1 identifies the book of the Bible as book 10, and the chapter in that book as chapter 4. The person would then read the fourth chapter of the tenth book of the Bible and reflect on the message in that chapter. Day two would be the second chapter in the 19^{th} book of the Bible, and so on. There must be at least two entry fields to identify a book and a chapter.

The numerical digits entered into the entry fields 10 for each day are obtained from a number generated by physical activity or exercise over a fixed period of time. The frequency of a physiological event that occurs over the fixed period of time can readily be measured. The most convenient physiological events to measure are movements of a body part such as the movement of a leg or arm or the chest. Also, the amount of times the heart beats and the amount of calories burned over a fixed period of time can be measured or calculated. The number of times these physiological events occur provides the number for entry of the digits of the number into the entry fields 10. Various devices for measuring physiological actions are well known, such as pedometers, heart rate monitors, and plethysmographs. Typical examples are the Omron Pocket Pedometer (HRM USA, Inc, Warminister, Pa.) which measures steps, calories, and distance, and the heart rate monitor with calorie expenditure by Bowflex™ (Southern Medical Supply, Columbia, S.C.). A heart rate monitor can be constructed to measure total heart beats just as a pedometer can measure total steps. Likewise, a plethysmograph can be attached to the chest wall to measure the rate of breathing or total number of breaths.

The books in the Bible can be assigned any number desired, but the most convenient approach is to number the books sequentially. For example, in the authorized King James Version of the bible there are 66 books from Genesis in the Old Testament to Revelation in the New Testament. Thus, Genesis would be book number 1 and Revelation would be book number 66.

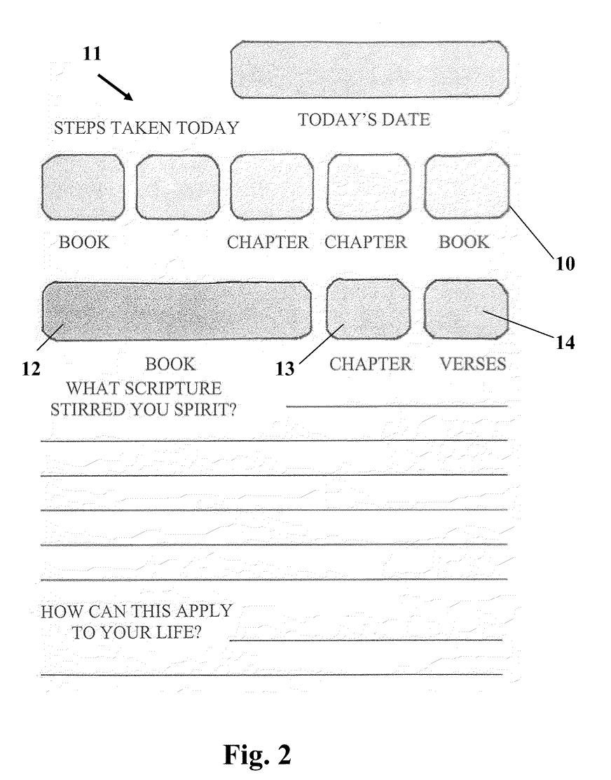

FIG. 2 illustrates an example of a recording media 11 for recording the number of a book of the Bible and a number of a chapter in the book, wherein the number of the book and the number of the chapter are derived from the digit entry fields 10 which were labeled randomly as “book” or “chapter”. When an individual obtains a number from the physiological measuring device after exerting some physical activity or exercise over a period of time on a given day, the user enters the digits of the number into the sequence of entry fields 10 provided for that day. Based upon the entry fields 10 that are labeled “book” the individual records the indicated book of the Bible into entry field 12. Based upon the entry fields 10 labeled “chapter” the individual records the indicated chapter of the indicated book of the Bible in entry field 13. The individual may also record the numbers of the verses of the indicated chapter in entry field 14. After reading the indicated chapter the individual may record on the recording media 11 specific thoughts related to the reading of the indicted chapter. The recording media 11 may provide questions such as “What scripture stirred your spirit?”, or “How can this scripture apply to your life?”, and so forth.

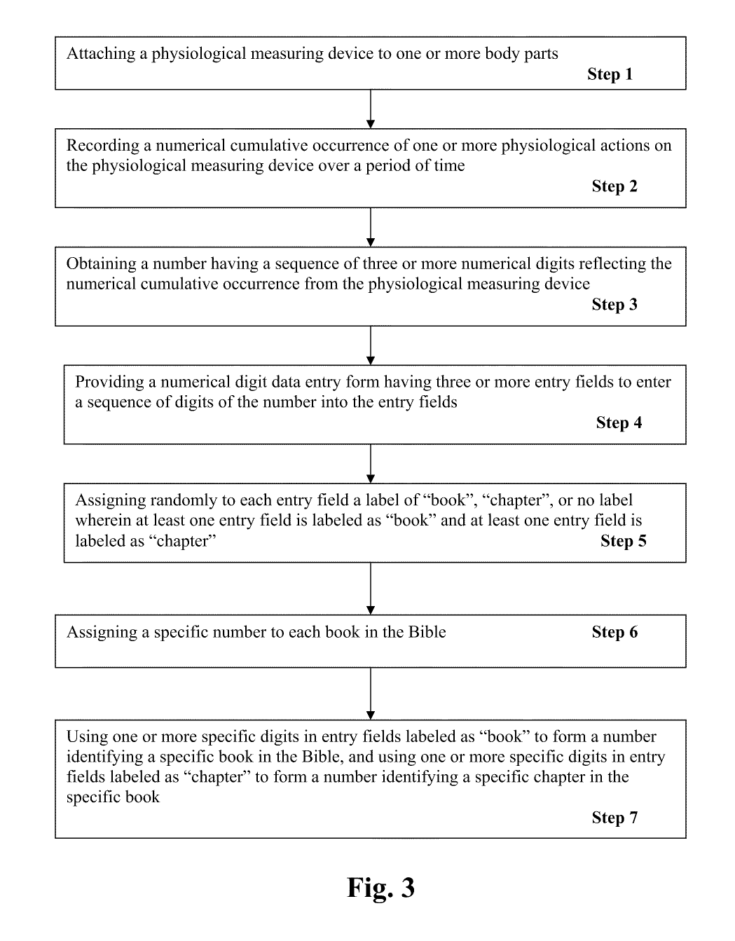

FIG. 3 describes the steps of the method of the present invention for identifying a specific chapter in a specific book of the Bible by measuring the frequency of occurrence of a physiological event during exercise or physical activity. A user attaches a physiological measuring device to one or more parts of the body. The measuring device can be a pedometer, heart rate meter, or plethysmograph, or a combination thereof (step 1). The user engages in physical activity or exercise for a desired period of time and records a numerical cumulative occurrence of one or more physiological actions on the physiological monitoring device over this period of time (step 2). The user obtains a number having a sequence of three or more digits reflecting the numerical cumulative occurrence from the physiological measuring device (step 3). The user is provided a data entry form or media 11 having three or more entry fields 10 to enter a sequence of digits of the number into the entry fields 10 (step 4). A label of “book”, “chapter”, or no label is assigned randomly to each entry field 10 wherein at least one entry field 10 is labeled as “book” and at least one entry field 10 is labeled as “chapter” (step 5). A specific number is assigned to each book of the Bible (step 6). The user forms a number identifying a specific book in the Bible using one or more specific digits labeled as “book”, and forms a number identifying a specific chapter in the specific book using one or more specific digits labeled as “chapter” (step 7). As noted above, the number of the book of the Bible can then be entered in a book entry field 12, and the number of the chapter in the book can be entered in a chapter entry field 13. The numbers of the verses may also be entered in a chapter verses entry field 14.

The foregoing description has been limited to specific embodiments of this invention. It will be apparent, however, that variations and modifications may be made by those skilled in the art to the disclosed embodiments of the invention, with the attainment of some of all of its advantages and without departing from the spirit and scope of the present invention. For example, any suitable type of physiological measuring device can be used to measure any type of repetitive body part movement or function to create a number of cumulative events. Total distance traveled by a user or a body part of the user may be used to obtain a number. The recording media or data entry form can be any type of hard copy recording media such as paper, books, or pamphlets, or any type of electronic recording media such as computers and audio-visual devices. The system and method of the present invention may be applied to any type of text which can be divided into books and chapters.

It will be understood that various changes in the details, materials, and arrangements of the parts which have been described and illustrated above in order to explain the nature of this invention may be made by those skilled in the art without departing from the principle and scope of the invention as recited in the following claims.

1. A method for randomly identifying a chapter in the Bible from the number of repetitions of a physiological action, comprising the steps of:
1) attaching a physiological measuring device to one or more body parts;
2) recording a numerical cumulative occurrence of one or more said physiological actions on said physiological measuring device over a period of time;
3) obtaining a number having a sequence of three or more numerical digits reflecting said numerical cumulative occurrence from said physiological measuring device; and
4) selecting one or more of said numerical digits randomly to identify a book in the Bible, and selecting one or more of said numerical digits randomly to identify a chapter in said book of the Bible.

2. The method of claim 1 wherein the step of selecting one or more of said numerical digits randomly to identify a book in the Bible, and selecting one or more of said numerical digits randomly to identify a chapter in said book of the Bible comprises the steps of:
1) providing a numerical digit data entry form having three or more entry fields to enter a sequence of said digits of said number into said entry fields;
2) assigning randomly to each of said entry fields a label of “book”, “chapter”, or no label wherein at least one entry field is labeled as “book” and at least one entry field is labeled as “chapter”; and
3) using one or more specific digits in said entry fields labeled as “book” to form a number identifying a specific book in the Bible, and using one or more specific digits in said entry fields labeled as “chapter” to form a number identifying a specific chapter in the specific book.

3. The method of claim 2 further comprising the step of assigning a specific number to each book in the Bible.

4. The method of claim 1 wherein said physiological measuring device includes devices to measure total number of steps taken, total number of movements of an arm, total number of heart beats, total number of breaths taken, total number of calories burned, or total distance traveled, or a combination thereof.

5. A method for randomly identifying a chapter in the Bible from the number of repetitions of a physiological action, comprising the steps of:
1) attaching a physiological measuring device to one or more body parts;
2) recording a numerical cumulative occurrence of one or more said physiological actions on said physiological measuring device over a period of time;
3) obtaining a number having a sequence of three or more numerical digits reflecting said numerical cumulative occurrence from said physiological measuring device; and
4) providing a numerical digit data entry form having three or more entry fields to enter a sequence of said digits of said number into said entry fields;
5) assigning randomly to each of said entry fields a label of “book”, “chapter”, or no label wherein at least one entry field is labeled as “book” and at least one entry field is labeled as “chapter”;
6) assigning a specific number to each book in the Bible.
7) using one or more specific digits in said entry fields labeled as “book” to form a number identifying a specific book in the Bible, and using one or more specific digits in said entry fields labeled as “chapter” to form a number identifying a specific chapter in the specific book.

6. The method of claim 5 wherein said physiological measuring device includes devices to measure, over a given period of time, total number of steps taken, total number of movements of an arm, total number of heart beats, total number of breaths taken, total number of calories burned, or total distance traveled, or a combination thereof.

7. A method for randomly identifying a chapter in the Bible from the number of repetitions of a physiological action, comprising the steps of:
1) attaching a physiological measuring device to one or more body parts, wherein said physiological measuring device includes devices to measure total number of steps taken, total number of movements of an arm, total number of heart beats, total number of breaths taken, total number of calories burned, or total distance traveled, or a combination thereof;
2) recording a numerical cumulative occurrence of one or more said physiological actions on said physiological measuring device over a period of time;
3) obtaining a number having a sequence of three or more numerical digits reflecting said numerical cumulative occurrence from said physiological measuring device; and
4) providing a numerical digit data entry form having three or more entry fields to enter a sequence of said digits of said number into said entry fields;
5) assigning randomly to each of said entry fields a label of “book”, “chapter”, or no label wherein at least one entry field is labeled as “book” and at least one entry field is labeled as “chapter”;
6) assigning a specific number to each book in the Bible.
7) using one or more specific digits in said entry fields labeled as “book” to form a number identifying a specific book in the Bible, and using one or more specific digits in said entry fields labeled as “chapter” to form a number identifying a specific chapter in the specific book.

8. A kit for using exercise to randomly identify chapters in the Bible for study, comprising:
1) a Bible;
2) one or more physiological measuring devices attachable to one or more body parts for recording a numerical cumulative occurrence of one or more physiological actions over a given period of time for obtaining a number having a sequence of three or more numerical digits reflecting said numerical cumulative occurrence; and
3) a recording media having three or more entry fields to enter a sequence of said digits of said number into said entry fields, wherein each of said entry fields is randomly assigned a label of “book”, “chapter”, or no label, and wherein at least one entry field is labeled as “book” and at least one entry field is labeled as “chapter”.

9. The kit of claim 8 wherein the books of the Bible are numbered sequentially, and wherein said one or more physiological measuring devices include devices to measure total number of steps taken, total number of movements of an arm, total number of heart beats, total number of breaths taken, total number of calories burned, or total distance traveled, or a combination thereof.
